(19) United States
(12) Patent Application Publication
(10) Pub. No.: US 2008/0007413 A1
(43) Pub. Date: Jan. 10, 2008

(54) WIRELESS TAG READING/WRITING APPARATUS, COMMUNICATION METHOD FOR THE WIRELESS TAG READING/WRITING APPARATUS AND WIRELESS TAG RELATING TO THE COMMUNICATION METHOD

(75) Inventor: Fusao Hori, Izu-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: TOSHIBA TEC KABUSHIKI KAISHA, Tokyo (JP)

(21) Appl. No.: 11/773,489

(22) Filed: Jul. 5, 2007

(30) Foreign Application Priority Data
Jul. 10, 2006 (JP) 2006-189396

(51) Int. Cl. G08B 13/14

(52) U.S. Cl. 340/572.7

(57) ABSTRACT

A terminated antenna, which is an antenna being terminated at ends, is provided, and the terminated antenna is electromagnetically connected with an antenna of a wireless tag to communicate. Thus, the remaining power or redundant power therewithin is transferred to the terminated antenna and is transformed to thermal energy at the ends. According to an embodiment, a communication antenna may be faced, in a non-contact manner, against a part or all of a closed plane or open plane formed by a wireless tag antenna, be electromagnetically connected with the wireless tag antenna. A terminated antenna may be faced, in a non-contact manner, against a part or all of a closed plane or open plane formed by a wireless tag antenna and be electromagnetically connected with the wireless tag antenna.

### CROSS-REFERENCE TO RELATED APPLICATIONS

This application is based upon and claims the benefit of priority from the prior Japanese Patent Application No. 2006-189396, filed on 10 Jul., 2006, the entire contents of which are incorporated herein by reference.

### BACKGROUND OF THE INVENTION

1. Field of the Invention

The present invention relates to a wireless tag reading/writing apparatus that exchanges a signal with a wireless tag, a communication method for the wireless tag reading/writing apparatus, and a wireless tag using the communication method and more specifically to a wireless tag reading/writing apparatus, communication method for the wireless tag reading/writing apparatus and wireless tag relating to the communication method, which can reduce radio waves radiated from a wireless tag during communication.

2. Description of the Related Art

The conventional wireless tag communication has been performed by electromagnetically connecting the entire antenna of a wireless tag and an antenna of a wireless tag reading/writing apparatus of a testing apparatus. However, during communication, a magnetic field is generated, and radio waves are radiated. When the communication is performed under a condition with densely provided wireless tags, the radio waves received by a wireless tag reading/writing apparatus are not determined as either radio waves from a wireless tag to communicate or radio waves from a wireless tag adjacent thereto, which is a problem. This problem significantly occurs by using a radio antenna with a long communicable distance.

A conventional technology relating to this may include JP-A-2003-263611 (called Patent Document 1, hereinafter). Patent Document 1 discloses a technology including electromagnetically connecting an antenna coil of a reader/writer and an antenna coil of a wireless tag, receiving, by the reader/writer, an impedance signal varying in accordance with a change in impedance due to the electromagnetic connection of the antenna of the wireless tag, and determining whether the reader/writer can read/write from/to the wireless tag or not from the impedance signal that the reader/writer has received.

The conventional technologies like this embodiment do not consider about radio waves radiated from wireless tags and do not even have the awareness of the issue that a specific wireless tag among densely provided wireless tags is to be read/written. For this reason, the conventional technologies cannot reduce the amount of the leak of radio waves in reading/writing information from/to a wireless tag.

Furthermore, in testing a wireless tag when a wireless tag is manufactured, the problems have been addressed by providing a shield against radio waves around a wireless tag to be tested in a testing step. However, it is difficult to efficiently shield the leak of radio waves, and the work efficiency is not good, either.

### BRIEF SUMMARY OF THE INVENTION

It is an object of the present invention to provide a wireless tag reading/writing apparatus that suppress the radiation of unnecessary radio waves in reading/writing a wireless tag.

In an aspect of the present invention, a wireless tag reading/writing apparatus includes a communication antenna, which is an antenna placed to face against, in a non-contact manner, a part or all of a closed plane or open plane formed by a wireless tag antenna that is an antenna of a wireless tag to communicate and to electromagnetically connect with the wireless tag antenna, and a terminated antenna, which is an antenna placed to face, in a non-contact manner, against a part or all of a closed plane or open plane formed by a wireless tag antenna and to electromagnetically connect with the wireless tag antenna and being terminated at ends.

### DESCRIPTION OF THE DRAWINGS

FIG. 1A is a diagram illustrating an outline of a wireless tag reading/writing apparatus of a first embodiment;

FIG. 1B is a diagram showing an embodiment of the open plane formed by a communication tag antenna;

FIG. 1C is a diagram showing an embodiment of the open plane formed by a terminated antenna;

FIG. 1D is a diagram showing an embodiment of the closed plane formed by an antenna of a wireless tag to be tested;

FIG. 2A is a diagram showing an embodiment in which both of a communication antenna and a terminated antenna are placed above a wireless tag to communicate;

FIG. 2B is a diagram showing an embodiment in which a communication antenna is placed above the wireless tag while a terminated antenna is placed below the wireless tag;

FIG. 2C is a diagram showing an embodiment in which a communication antenna is placed below the wireless tag while a terminated antenna is placed above the wireless tag;

FIG. 3 is a top view of the wireless tag reading/writing apparatus of the first embodiment;

FIG. 4A is a diagram illustrating an outline of a wireless tag reading/writing apparatus of a second embodiment of the invention;

FIG. 4B is a diagram showing an embodiment in which a communication tag antenna and a terminated antenna are placed above a wireless tag;

FIG. 5 is a top view of the wireless tag reading/writing apparatus of the second embodiment of the invention;

FIG. 6A is a diagram illustrating an outline of a wireless tag reading/writing apparatus of a third embodiment of the invention;

FIG. 6B is a diagram showing an embodiment in which a communication tag antenna and a terminated antenna are placed above a wireless tag;

FIG. 7 is a perspective view of the wireless tag reading/writing apparatus of the third embodiment of the invention;

FIG. 8 is a diagram showing a testing method when wireless tags 601 to be tested are aligned on a sheet 601a; and

FIG. 9 is a diagram schematically illustrating a construction of a wireless tag reading/writing apparatus of this embodiment.

### DETAILED DESCRIPTION OF THE INVENTION

Throughout this description, the embodiments and embodiments shown should be considered as exemplars, rather than limitations on the apparatus and methods of the present invention.

With reference to drawings, an embodiment of the invention will be described below. According to the invention, a wireless tag reading/writing apparatus includes an apparatus that reads information from a wireless tag, an apparatus that writes information to a wireless tag, or an apparatus that reads and writes information from and to a wireless tag. The wireless tag refers to a storage medium that can perform wireless communication and generally has an antenna and an IC chip. The wireless tag may further have a calculation function and desirably has a portable size but may be minute. The wireless tag may be called RFID (Radio Frequency Identification) tag.

### Outline of Embodiments

First of all, an outline of a mechanism of a wireless tag reading/writing apparatus of an embodiment will be described. The wireless tag reading/writing apparatus of the embodiment includes a terminated antenna, which is an antenna being terminated at ends, and the terminated antenna is electromagnetically connected with an antenna of a wireless tag to communicate.

In this construction, remaining power or redundant power is transferred to the terminated antenna and is transformed to thermal energy at the ends.

The embodiment for implementing the mechanism will be described in order below.

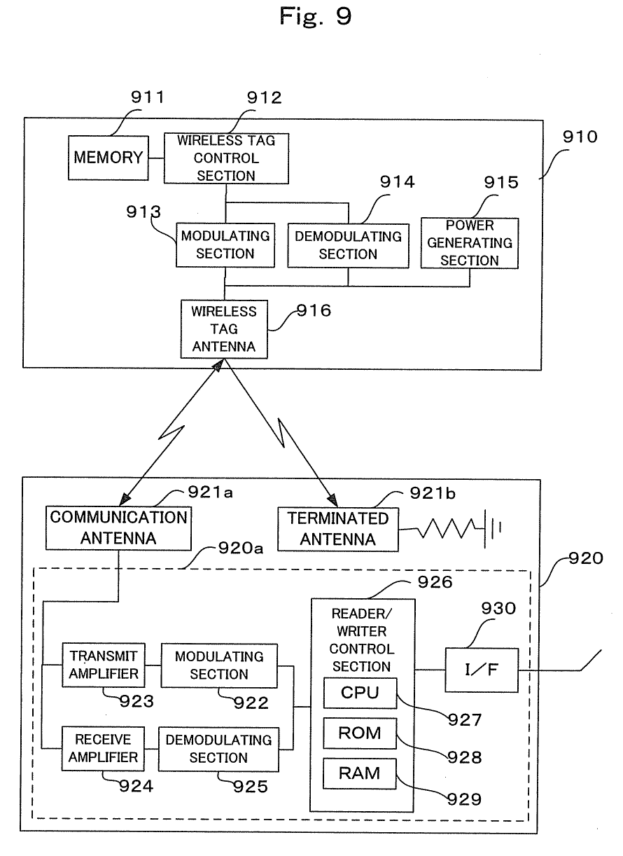

Next, an outline of the embodiment will be described. FIG. 9 is a diagram showing an outline of the construction of a wireless tag reading/writing apparatus of the embodiment.

A wireless tag 910 includes a memory 911, a wireless tag control section 912, a power generating section 915, a modulating section 913 and a demodulating section 914. The memory 911 is a storage device. The wireless tag control section 912 reads/writes data from/to the memory 911. The power generating section 915 supplies power by rectifying and stabilizing received modulated electromagnetic waves. The modulating section 913 modulates data transmitted from the wireless tag control section 912 and transmits the result to a wireless tag antenna 916. The demodulating section 914 demodulates received modulated electromagnetic waves and transmits the result to the wireless tag control section 912.

A wireless tag reading/writing apparatus 920 of this embodiment includes a communication antenna 921a, a terminated antenna 921b and a reader/writer 920a. The communication antenna 921a is an antenna for exchanging signals with a wireless tag by electromagnetic waves. The terminated antenna 921b is terminated at an end. The reader/writer 920a performs signal processing.

The reader/writer 920a includes a reader/writer control section 926, a modulating section 922, a transmit amplifier 923, a receive amplifier 924, a demodulating section 925 and an interface 930. The reader/writer control section 926 controls hardware that communicates with and connects to the wireless tag 910. The modulating section 922 modulates data transmitted from the reader/writer control section 926. The transmit amplifier 923 amplifies a modulated signal and transmits the result to the communication antenna 921a. The receive amplifier 924 amplifies received modulated electromagnetic waves. The demodulating section 925 demodulates a received modulated signal. The interface 930 connects to an upper apparatus such as a personal computer and transmits or receives data. The reader/writer control section 926 includes a CPU 927 and a ROM 928 and a RAM 929, which store data.

The wireless tag reading/writing apparatus 920 may be a stationary or hand-held type wireless tag reading/writing apparatus with the communication antenna 921a and terminated antenna 921b integrally stored in a cabinet thereof. Alternatively, the communication antenna 921a and terminated antenna 921b may be stored in a separate cabinet from that of the wireless tag reading/writing apparatus 920.

Next, an outline of a wireless tag reading/writing apparatus of the invention will be described. The wireless tag reading/writing apparatus of one aspect of the invention includes a communication antenna, which is an antenna placed, in a non-contact manner, to electromagnetically connect with a wireless tag antenna, which is an antenna of a wireless tag to communicate, a terminated antenna, which is an antenna placed, in a non-contact manner, to electromagnetically connect with a wireless tag antenna and being terminated at ends, and a reader/writer that performs signal processing.

A wireless tag communication method of another aspect of the invention includes the steps of electromagnetically connecting a communication antenna, which is an antenna exchanging electromagnetic waves of a wireless tag reading/writing apparatus that communicates with a wireless tag, to a wireless tag antenna, which is an antenna of the wireless tag to communicate, electromagnetically connecting a terminated antenna, which is an antenna being terminated at ends, to the wireless tag antenna, and exchanging information with the wireless tag by the wireless tag reading/writing apparatus.

A wireless tag of another aspect of the invention communicates with a wireless tag reading/writing apparatus having a communication antenna, which is an antenna placed to face, in a non-contact manner, against a part or all of a closed plane or open plane formed by a wireless tag antenna that is an antenna of a wireless tag to communicate and to electromagnetically connect with the wireless tag antenna, a terminated antenna, which is an antenna placed to face, in a non-contact manner, against a part or all of a closed plane or open plane formed by the wireless tag antenna and to electromagnetically connect with the wireless tag antenna and being terminated at ends, and a reader/writer that performs signal processing. In this case, the wireless tag antenna transfers the remaining power or redundant power within a wireless tag to the terminated antenna. Details will be described below.

### Embodiment 1

Embodiment 1 is an embodiment in which a wireless tag reading/writing apparatus includes a terminated antenna separately from a communication antenna, and in which remaining power or redundant power within a wireless tag is transferred to the terminated antenna and is transformed to thermal energy by electromagnetically connecting the terminated antenna to an antenna of the wireless tag and will be described below.

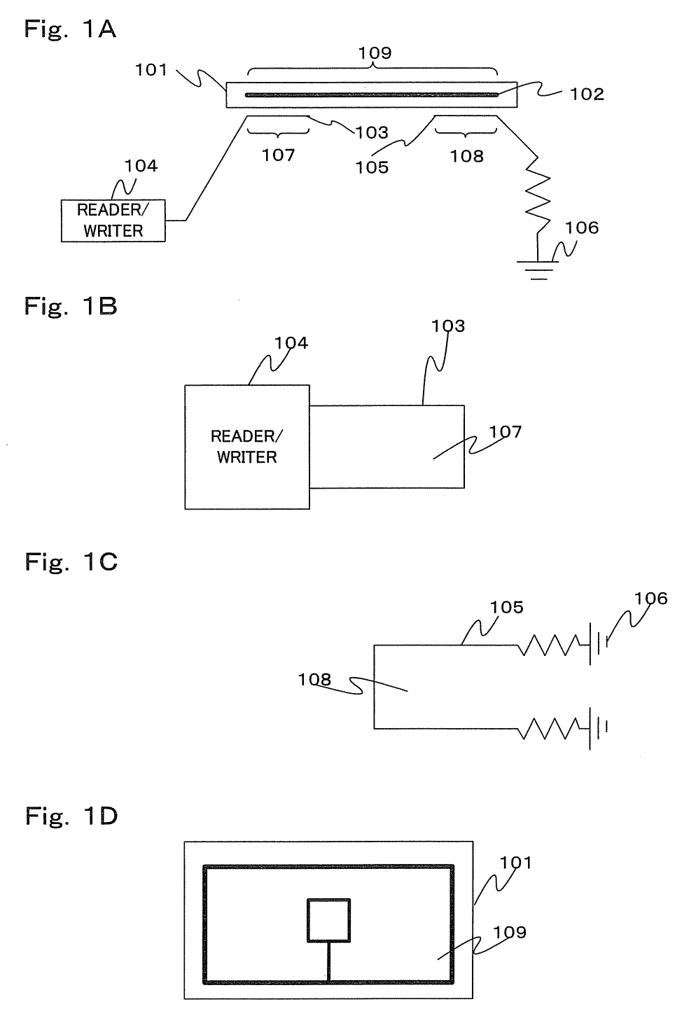

FIG. 1A is a diagram illustrating an outline of a wireless tag reading/writing apparatus of Embodiment 1 of the invention. FIG. 1A is a side view of the wireless tag reading/writing apparatus of this embodiment.

As shown in FIG. 1A, the wireless tag reading/writing apparatus of this embodiment includes a communication antenna 103, which is an antenna placed to face, in a non-contact manner, against a part or all of a closed plane or open plane 109 formed by a wireless tag antenna 102, which is an antenna of a wireless tag 101 to communicate, and to electromagnetically connect with the wireless tag antenna 102, a terminated antenna 105, which is an antenna placed to face, in a non-contact manner, against a part or all of a closed plane or open plane 109 formed by the wireless tag antenna 102 and to electromagnetically connect with the wireless tag antenna 102 and being terminated at ends 106, and a reader/writer 104 that performs signal processing.

The communication antenna 103 may form a closed plane or open plane. The terminated antenna 105 may form a closed plane or open plane.

FIG. 1B shows an embodiment of an open plane 107 formed by the communication tag antenna 103. As shown in FIG. 1B, the open plane formed by the communication tag antenna 103 refers to a plane to which an open figure formed by the communication tag antenna 103 belongs. The expression, “open plane”, is used here by the meaning.

The communication tag antenna 103 may form a closed figure.

FIG. 1C shows an embodiment of an open plane 108 formed by the terminated antenna 105. The terminated antenna 105 may form a closed figure.

FIG. 1D shows an embodiment of the closed plane 109 formed by the antenna 102 of a wireless tag to be tested. As shown in FIG. 1D, the closed plane formed by the antenna 102 of a wireless tag to be tested refers to a plane to which an closed figure formed by the antenna 102 of a wireless tag to be tested belongs. The expression, “closed plane”, is used here by the meaning.

The antenna 102 of the wireless tag 101 to be tested may form an open plane.

Next, a layout embodiment of the wireless tag reading/writing apparatus of this embodiment will be described. In FIG. 1A, the communication antenna 103 and the terminated antenna 105 are placed below the wireless tag 101 to communicate with both of them. Alternatively, the communication antenna 103 and the terminated antenna 105 may be placed as follows.

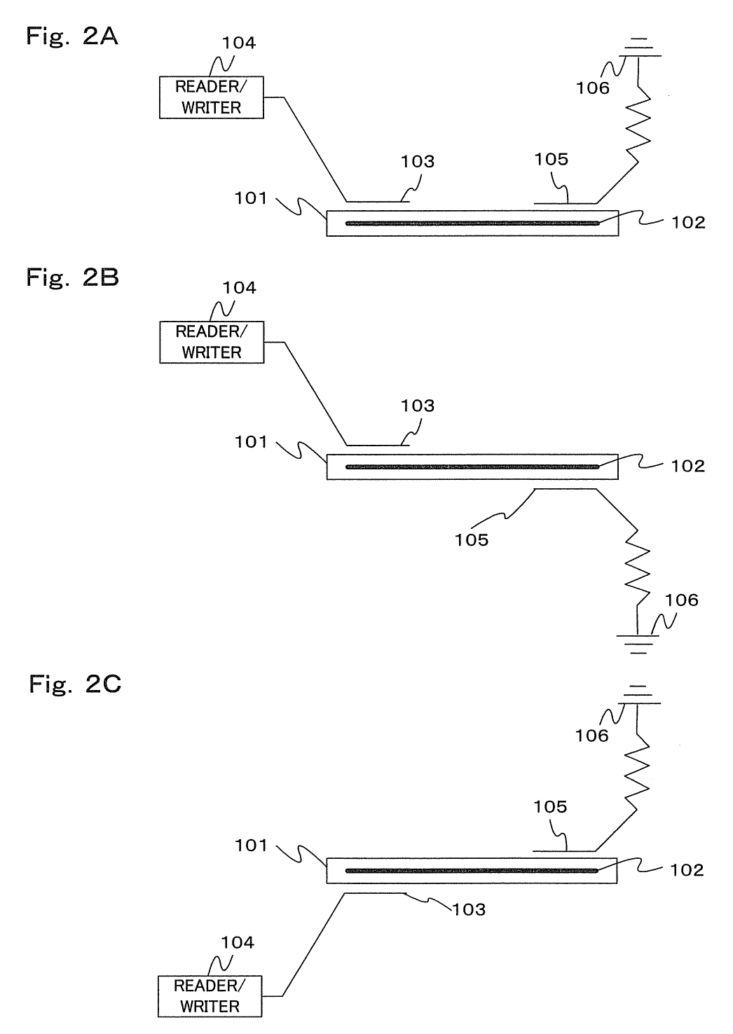

FIG. 2A shows an embodiment in which the communication antenna 103 and the terminated antenna 105 are placed above the wireless tag 101 to communicate by both of them. FIG. 2B shows an embodiment in which the communication antenna 103 is placed above the wireless tag 101, and the terminated antenna 105 is placed below the wireless tag 101. FIG. 2C shows an embodiment in which the communication antenna 103 is placed below the wireless tag 101, and the terminated antenna 105 is placed above the wireless tag 101.

Now, a mechanism will be described that suppresses the radiation of unnecessary radio waves by the wireless tag reading/writing apparatus of Embodiment 1. In a wireless tag testing method of Embodiment 1, a part of the closed plane or open plane formed by the communication tag antenna 103 connecting to the reader/writer 104 is placed to face, in a non-contact manner, against a part of the closed plane or open plane formed by the antenna 102 of the wireless tag to be tested. Then, the communication tag antenna is electromagnetically connected with the wireless tag antenna. Furthermore, a part of the closed plane or open plane formed by the terminated antenna being terminated at ends is placed to face, in a non-contact manner, against a part or all of the remaining part of the closed plane or open plane formed by the antenna of the wireless tag to be tested. Then, the terminated antenna is electromagnetically connected to the antenna of the wireless tag. Then, the wireless tag reading/writing apparatus reads or write information from or to the wireless tag to communicate.

When current flows from the reader/writer 104 to the communication tag antenna, the electromagnetic connection with the wireless tag antenna 102 of the wireless tag 101 occurs. Then, power is transferred to the wireless tag antenna 102, and an IC chip of the wireless tag operates. A signal from the IC chip is transmitted to the wireless tag antenna 102, the electromagnetically connected communication tag antenna 103 and the reader/writer 104.

Substantially 50% of the power applied to the communication tag antenna is transformed to energy that operates the wireless tag, and the remaining part of the applied power is transferred to the terminated antenna 105 by the electromagnetic connection and is transformed to heat in the ends 106. Also, when remaining power or redundant power is applied to the communication tag antenna, the power is transformed to heat in the ends 106 through the terminated antenna 105.

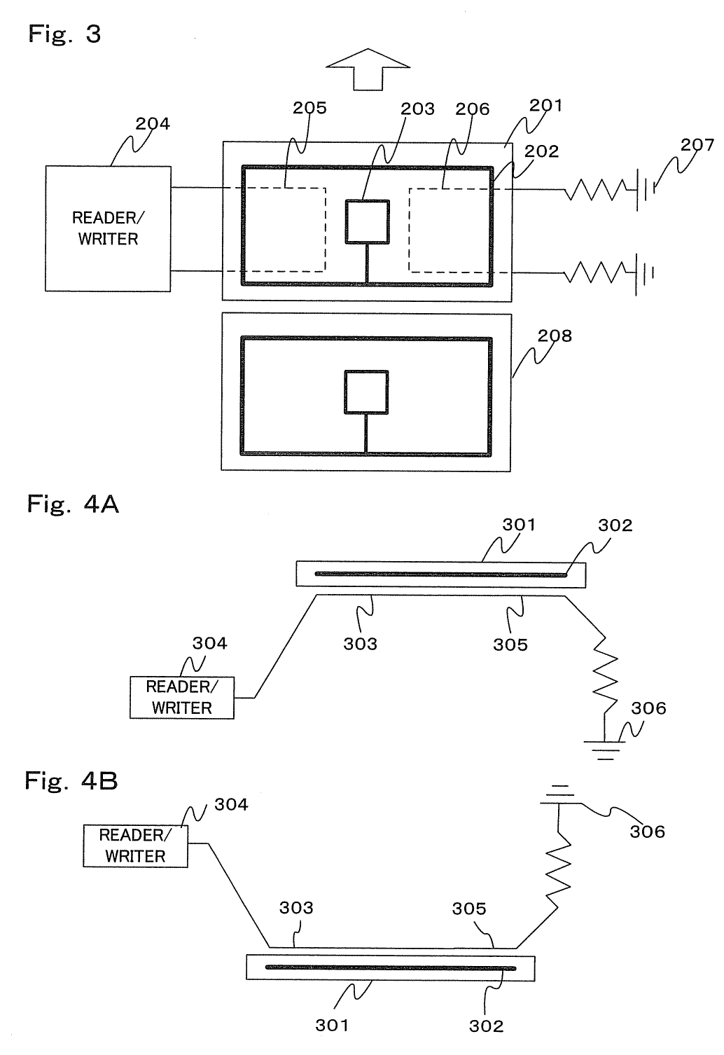

FIG. 3 is a top view of the wireless tag reading/writing apparatus of Embodiment 1 of the invention and, in particular, shows the wireless tag in a testing step during a manufacturing process. A wireless tag 201 and a wireless tag 208 move in the direction of the arrow and closely to each other in a testing step. An antenna 202 is provided around the circumference of an IC chip 203 of the wireless tag 201. Though FIG. 3 shows a folded-dipole antenna as the antenna, the advantages of the invention can be obtained even with any kind of antenna. A communication tag antenna 205 connects to a reader/writer 204. A terminated antenna 206 is terminated at ends 207.

Here, the power applied to the communication tag antenna 205 by the reader/writer 204 is transferred to the antenna 202 of the electromagnetically-connected wireless tag, which operates the wireless tag. The remaining power or redundant power is transferred to the electromagnetically-connected terminated antenna 206 and is transformed to heat in the ends 207.

With this construction, the wireless tag reading/writing apparatus and wireless tag communication method of this embodiment can suppress the radiation of radio waves to a space, and the reader/writer can only receive signals from the wireless tag 201, which is currently being tested.

### Embodiment 2

Embodiment 2 is an embodiment in which the wireless tag reading/writing apparatus includes a terminated antenna as an integrated member electrically connected to a communication antenna, and in which remaining power or redundant power within a wireless tag is transferred to the terminated antenna and is transformed to thermal energy by electromagnetically connecting the terminated antenna to an antenna of the wireless tag and will be described below.

FIG. 4A is a diagram illustrating an outline of a wireless tag reading/writing apparatus of Embodiment 2 of the invention. FIG. 4A shows a side view of a wireless tag reading/writing apparatus of this embodiment.

In this embodiment, a communication tag antenna 303 and a terminated antenna 305 are electrically connected, and the other construction and mechanism are identical to those of Embodiment 1. A wireless tag 301 has an antenna 302. A reader/writer 304 connects to a communication tag antenna 303. The terminated antenna 305 is terminated at an end 306. While the communication tag antenna 303 and terminated antenna 305 are placed below the wireless tag 301 in FIG. 4A, they may be placed above the wireless tag as shown in FIG. 4B.

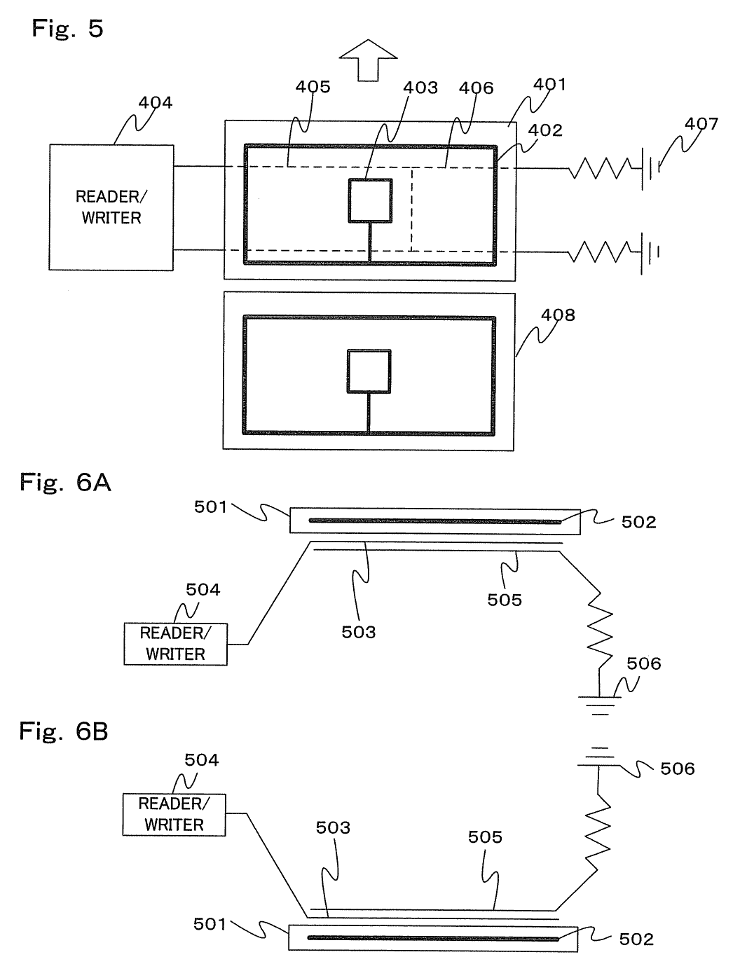

FIG. 5 is a top view of the wireless tag reading/writing apparatus of Embodiment 2 of the invention and shows a wireless tag in a testing step during a manufacturing process, for embodiment. A wireless tag 401 has a wireless tag antenna 402 and an IC chip 403. A communication tag antenna 405 is placed around the IC chip 403 and in non-contact with the wireless tag and connects to a reader/writer 404. A terminated antenna 406 is electrically connected to the communication tag antenna 405, is placed over a part of the wireless tag 401 in non-contact with the wireless tag 401 and is terminated at ends 407.

With this construction, the wireless tag reading/writing apparatus and wireless tag communication method of this embodiment can suppress the radiation of radio waves to a space, and the reader/writer can only receive signals form the wireless tag 401, which is currently being tested, though the wireless tag 408 in a testing step is conveyed in the direction of the arrow and closely to the wireless tag 401, which is being tested.

### Embodiment 3

Embodiment 3 is an embodiment in which a wireless tag reading/writing apparatus includes a terminated antenna separately from a communication antenna, in which the terminated antenna is placed to face against the communication antenna in two layers in a non-contact manner and in which remaining power or redundant power within a wireless tag is transferred to the terminated antenna and is transformed to thermal energy by electromagnetically connecting the communication antenna and terminated antenna to an antenna of the wireless tag and will be described below.

FIG. 6A is a diagram illustrating an outline of a wireless tag reading/writing apparatus of Embodiment 3 of the invention. FIG. 6A is a side view of the wireless tag reading/writing apparatus of this embodiment.

In the wireless tag reading/writing apparatus of Embodiment 3, the closed plane or open plane formed by a communication tag antenna 503 and the closed plane or open plane formed by the terminated antenna 505 are placed to face against each other in two layers in a non-contact manner.

While the communication tag antenna 503 and terminated antenna 505 are placed below the wireless tag 501 in FIG. 6A, they may be placed above the wireless tag as shown in FIG. 6B.

A part or all of a closed plane or open plane formed by the communication tag antenna 503 connecting to the reader/writer 504 is placed to face, in a non-contact manner, against a part or all of a closed plane or open plane formed by the antenna 502 of the wireless tag 501 to be tested. Then, the communication tag antenna 503 is electromagnetically connected with the wireless tag antenna 502 of the wireless tag.

A part of the closed plane or open plane formed by the terminated antenna 505 being terminated at ends is placed to face, in a non-contact manner, against a part or all of the closed plane or open plane formed by the antenna 502 of the wireless tag. Then, the terminated antenna 505 is electromagnetically connected to the antenna of the wireless tag. The other construction and mechanism are identical to those of Embodiment 1.

The wireless tag 501 has the antenna 502. The communication tag antenna 503 is connected to the reader/writer 504. The terminated antenna 505 is terminated at an end 506. While both of the communication tag antenna 504 and terminated antenna 505 are positioned below the wireless tag 501 in FIG. 5, one or both of them may be positioned above the wireless tag.

FIG. 7 is a perspective view of the wireless tag reading/writing apparatus of Embodiment 3 of the invention. For clear illustration, larger spaces are provided among a wireless tag 601, a communication tag antenna 602 and a terminated antenna 604 in FIG. 7, but the spaces are desirably smaller. The communication tag antenna 602 is connected to the reader/writer 603, and the terminated antenna 604 is terminated at ends 605.

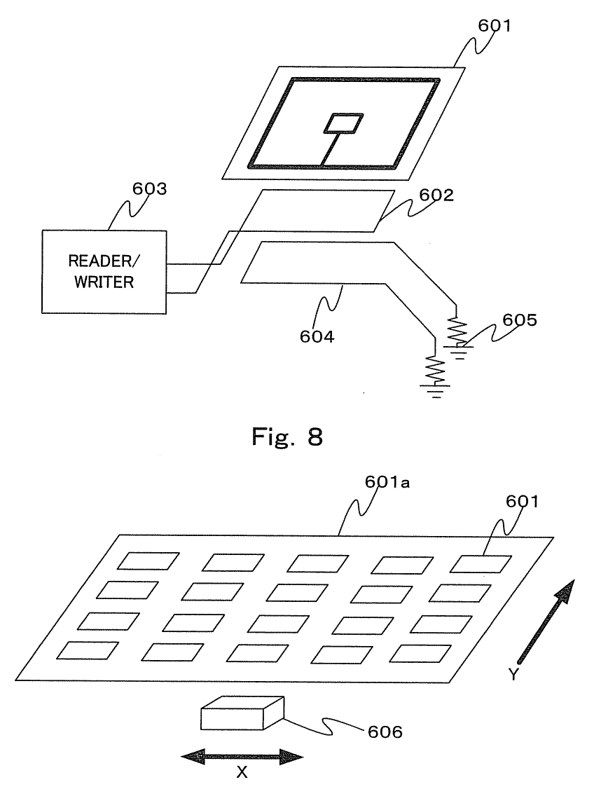

FIG. 8 is a diagram showing a testing method when the wireless tags 601 to be tested are aligned on a sheet 601a. The wireless tag reading/writing apparatus 606 moves in the direction of the arrow X and communicates with the wireless tags 601 sequentially to test the wireless tags 601. After one horizontal array has been tested, the sheet 601a moves in the direction of the arrow Y. Then, the next array is tested. In this way, by moving the wireless tag reading/writing apparatus 606, the wireless tags can be tested more efficiently.

In this embodiment, the closed plane or open plane formed by the communication tag antenna 602 and the closed plane or open plane formed by the terminated antenna 604 are placed to face against each other in two layers in a non-contact manner, and these antennas are electromagnetically connected to the antenna of a wireless tag to communicate. Thus, substantially all of radio waves radiated to a space can be transformed to heat by the ends 605 of the terminated antenna.

With this construction, the wireless tag testing method of this embodiment can suppress most of the radiation of radio waves to a space, and the reader/writer can only receive signals from the wireless tag 601, which is currently being tested.

Although exemplary embodiments of the present invention have been shown and described, it will be apparent to those having ordinary skilled in the art that a number of changes, modifications, or alterations to the invention as described herein may be made, none of which depart from the spirit of the present invention. All such changes, modifications, and alterations should therefore be seen as within the scope of the present invention.

What is claimed is:

1. A wireless tag reading/writing apparatus that exchanges information with a wireless tag to communicate, the reading/writing apparatus comprising:
a communication antenna, which is an antenna placed, in a non-contact manner, to electromagnetically connect with a wireless tag antenna, which is an antenna of the wireless tag;
a terminated antenna, which is an antenna placed, in a non-contact manner, to electromagnetically connect with the wireless tag antenna and being terminated at ends; and
a reader/writer that performs signal processing.

2. A wireless tag reading/writing apparatus that exchanges information with a wireless tag to communicate, the apparatus comprising:
a communication antenna, which is an antenna placed to face against, in a non-contact manner, a part or all of a closed plane or open plane formed by a wireless tag antenna, which is an antenna of the wireless tag, and to electromagnetically connect with the wireless tag antenna;
a terminated antenna, which is an antenna placed to face against, in a non-contact manner, a part or all of a closed plane or open plane formed by the wireless tag antenna and to electromagnetically connect with the wireless tag antenna and being terminated at ends; and
a reader/writer that performs signal processing.

3. The wireless tag reading/writing apparatus according to claim 1, wherein the communication antenna forms a closed plane or open plane.

4. The wireless tag reading/writing apparatus according to claim 1, wherein the terminated antenna forms a closed plane or open plane.

5. The wireless tag reading/writing apparatus according to claim 1, wherein the communication antenna and the terminated antenna are placed to face against each other in two layers in a non-contact manner.

6. The wireless tag reading/writing apparatus according to one of claims 1 to 5, wherein one or both of the communication antenna and the terminated antenna is or are placed above or below the closed plane or open plane formed by the wireless tag antenna.

7. A wireless tag communication method comprising the steps of:
electromagnetically connecting a communication antenna, which is an antenna exchanging electromagnetic waves of a wireless tag reading/writing apparatus that communicates with a wireless tag, to a wireless tag antenna, which is an antenna of the wireless tag to communicate;
electromagnetically connecting a terminated antenna, which is an antenna being terminated at ends, to the wireless tag antenna; and
exchanging information with the wireless tag by the wireless tag reading/writing apparatus.

8. The wireless tag communication method according to claim 7, wherein:
the communication antenna is placed to face, in a non-contact manner, against a part or all of a closed plane or open plane formed by the wireless tag antenna and is electromagnetically connected with the wireless tag antenna; and
the terminated antenna is placed to face, in a non-contact manner, against a part or all of a closed plane or open plane formed by the wireless tag antenna and is electromagnetically connected with the wireless tag antenna.

9. The wireless tag communication method according to claim 7, wherein:
the communication antenna is placed to face, in a non-contact manner, against a part or all of a closed plane or open plane formed by the wireless tag antenna and is electromagnetically connected with the wireless tag antenna; and
the terminated antenna is placed to face against a part or all of a closed plane or open plane formed by the wireless tag antenna in two layers in a non-contact manner and is electromagnetically connected with the wireless tag antenna.

10. A wireless tag that communicates with a wireless tag reading/writing apparatus having:
a communication antenna, which is an antenna placed to face, in a non-contact manner, against a part or all of a closed plane or open plane formed by a wireless tag antenna that is an antenna of a wireless tag to communicate and to electromagnetically connect with the wireless tag antenna;
a terminated antenna, which is an antenna placed to face, in a non-contact manner, against a part or all of a closed plane or open plane formed by the wireless tag antenna and to electromagnetically connect with the wireless tag antenna and being terminated at ends; and
a reader/writer that performs signal processing,
wherein the wireless tag antenna transfers the remaining power or redundant power within a wireless tag to the terminated antenna.
